(19) United States
(12) Patent Application Publication
(10) Pub. No.: US 2015/0284246 A1
(43) Pub. Date: Oct. 8, 2015

(54) GAS GENERATOR, IN PARTICULAR FOR GASEOUS HYDROGEN

(71) Applicant: WORGAS BRUCIATORI S.R.L., Formigine (Modena) (IT)

(72) Inventors: Giulio Cenci, Ferrara (IT); Ermanno Righi, Modena (IT); Fabrizio Sibani, Casalgrande (IT); Francesco Vizza, Firenze (IT); Sabrina Magnani, Maranello (IT); Andrea Marchionni, Agliana (IT); Claudio Bianchini, Firenze (IT); Jonathan Filippi, Prato (IT)

(73) Assignee: WORGAS BRUCIATORI S.R.L., Formigine (Modena) (IT)

(21) Appl. No.: 14/440,459

(22) PCT Filed: Dec. 21, 2012
(86) PCT No.: PCT/IT2012/000397

§ 371 Date: May 4, 2015

(51) Int. Cl. C01B 3/08; B01J 19/24; C01B 3/06; B01J 7/02

(52) U.S. Cl. CPC C01B 3/08; B01J 7/02; B01J 19/24; C01B 3/065; B01J 2219/24

(57) ABSTRACT

A gas generator, comprising: a reactor (2), arranged to contain a preset quantity of reactants; a connection conduit (4), arranged to hermetically connect the reactor (2) to a user (U) of the gas produced; the reactor (2) comprises a container (21) equipped with an opening (22) provided with a breakable hermetic barrier (23); connection means (5) are arranged to allow the hermetic and removable connection of the container (21) to the connection conduit (4) and to determine the breaking of the hermetic barrier (23) following the connection between the container (21) and the connection conduit (4).

The present invention relates to a gas generator.

The invention refers in particular to a generator for producing gas from a reaction between two or more reactants, at least one of which having a certain toxicity or a certain hazardousness for the user.

A preferred use of the generator according to the present invention is in the production of hydrogen for the supply of gaseous hydrogen to one or more fuel cells.

Various gaseous hydrogen generators are currently available on the market to be used for producing electrical energy through fuel cells.

Hydrogen generators generally comprise a reactor within which hydrogen is produced following a chemical reaction typically of a hydrolytic nature.

The reactor is generally connected to a vapour separator, within which the hydrogen is separated from the water. The vapour separator is in turn connected to a filter through which the hydrogen is supplied to the user, for example a fuel cell.

Some of the most effective reactions for producing hydrogen take place between metals or metal hydrides, such as for example aluminium or sodium borohydride (NaBH₄), and acidic or basic substances, such as for example hydrochloric acid (HCl) or caustic soda (NaOH). However, a wide variety of chemical reactions are known that give rise to the production of hydrogen.

In general the reactants used for producing hydrogen have a certain degree of hazardousness and/or toxicity. Consequently the transport, handling and disposal of such reactants require different safety steps, or are even subject to safety standards codified in a rather stringent way.

This makes the common use of hydrogen generators somewhat problematic, hindering their introduction for domestic uses or mass consumption since, in the generators currently available, it is necessary to remove the waste reactants from inside the reactor and restore the necessary amounts of reactants ready to use within the generator itself.

The object of the present invention is to make a gas generator available, and in particular a gaseous hydrogen generator, which enables the disadvantages of the generators currently available on the market to be overcome.

An advantage of the generator according to the present invention is that it allows the disposal and the refill of the reactor in complete safety, without needing to come into contact with the reactants.

Another advantage of the generator is that it is simple and suitable for use by non-specialist operators.

Further characteristics and advantages of the present invention will become clear from the following detailed description of an embodiment of the invention in question, illustrated by way of non-limiting example in the attached figures wherein:

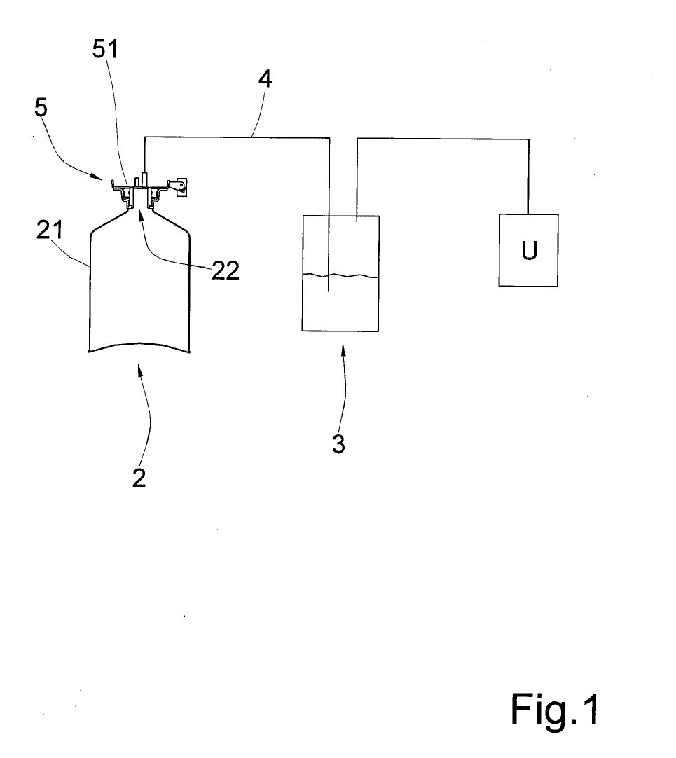

FIG. 1 shows a schematic view of a generator according to the present invention;

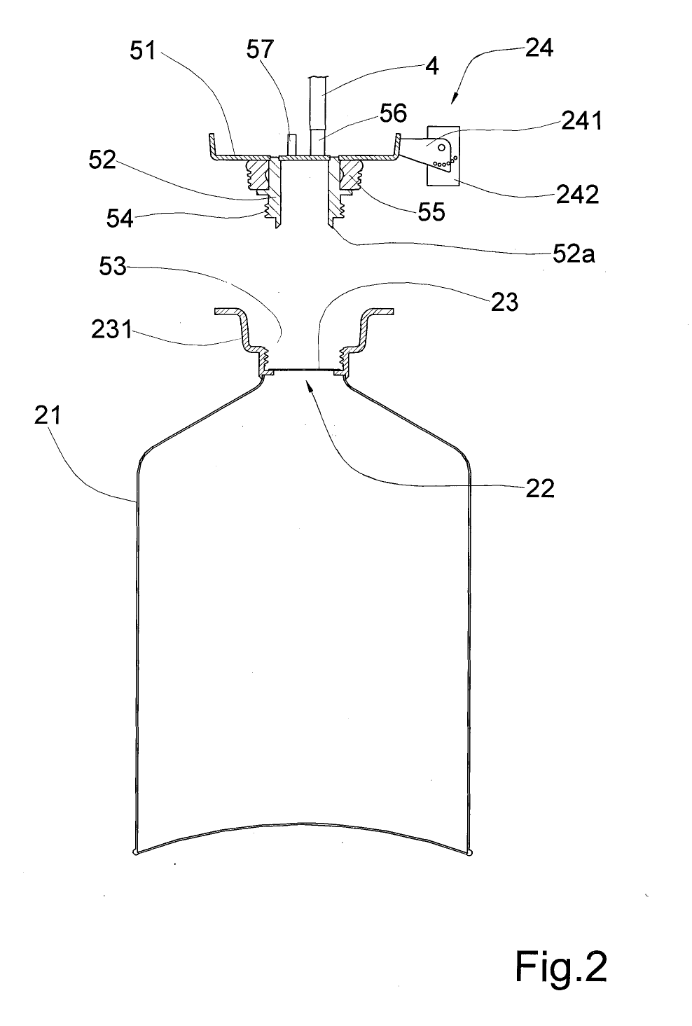

FIG. 2 shows a sectional view of the reactor (2) of the generator according to the present invention, in an operating condition prior to the connection of the reactor to the generator;

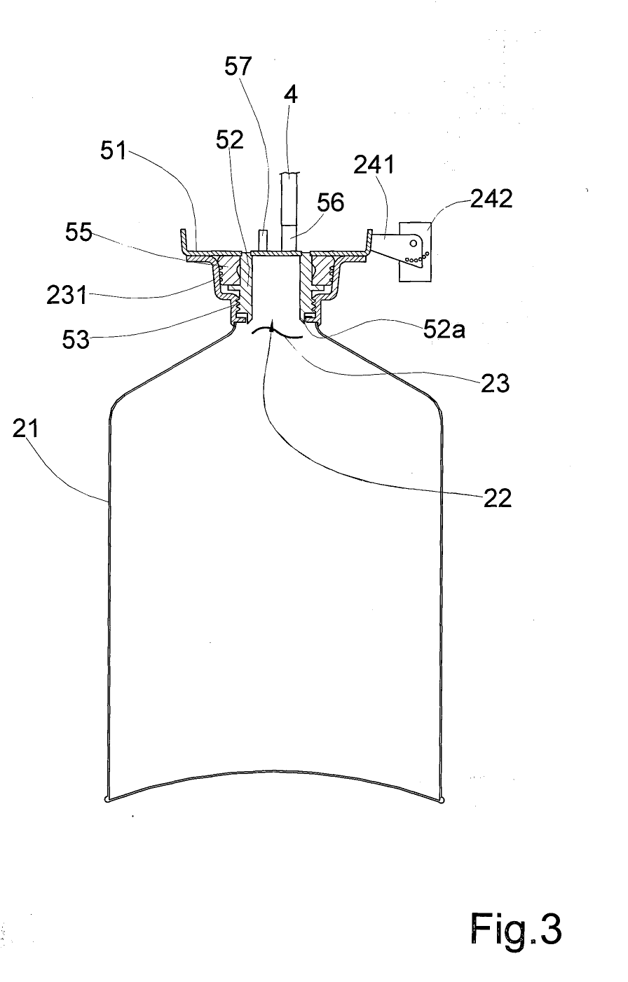

FIG. 3 shows a sectional view of the reactor (2) of the generator according to the present invention, in an operating condition following the connection of the reactor to the generator.

As already mentioned in the introductory part of the description, the gas generator according to the present invention is particularly suitable for producing hydrogen, and the description as follows will refer to this preferred designation. The hydrogen produced can be used to supply fuel cells, as a fuel for supplying a burner, for storage, for laboratory uses, or for another use. This does not exclude the possibility that the generator can however be used for producing different gases from hydrogen.

The gas generator according to the present invention comprising a reactor (2), is intended to contain the necessary reactants for producing a determined gaseous substance. In the preferred use of the reactor for producing hydrogen, the reactants may be for example aluminium and water which, with the addition of caustic soda, produce hydrogen according to the following reaction:

2Al+2NaOH+6H₂O→2NaAl(OH)₄+3 H₂.

Another example of a reaction for producing hydrogen involves sodium borohydride which reacts with water according to the following reaction:

NaBH₄+2H₂O→NaBO₂+4H₂.

The reactor (2) is connected to a user (U) of the gas produced through a connection conduit (4). In the preferred example of use, the user (U) is a fuel cell. Preferably, but not necessarily, at least one vapour separator (3) and/or one or more filtering devices are interposed between the reactor (2) and the user (U). The vapour separator (3) is particularly useful for enabling the separation of the gas produced from any vapour produced by the reaction.

The reactor (2) comprises a container (21) equipped with an opening (22) provided with a breakable hermetic barrier (23). Connection means (5) are provided to enable the hermetic and removable connection of the container (21) to the connection conduit (4) and to determine the breaking of the hermetic barrier (23) following the connection between the container (21) and the connection conduit (4). The connection means (5) are also structured so as to enable the introduction of at least one reactant into the container (21). The presence of a reactor (2) and connection means (5) having the characteristics described above offers very important advantages. First of all, once the reactants contained within the reactor (2) are depleted, the generator can be refilled by replacing the reactor (2) containing the depleted reactants with a new reactor (2) containing active reactants in the right quantities and proportions. This enables the operation of the generator to be restored without directly handling the reactants, but simply by replacing the depleted reactor (2) with a new reactor. The management of the reserves of reactants for the operation of the generator therefore turns into more simple management of a store of reactors (2) which are, substantially, in the form of hermetically closed containers before use.

In a preferred embodiment of the generator, the connection means (5) comprise a connector (51), associated with the connection conduit (4), which is provided with a breaking portion (52) arranged to break the hermetic barrier (23) following the connection between the container (21) and the connection conduit (4). The breaking portion (52) projects from one side of the connector (51) intended to face towards the opening (22) of the container (21) and has a pointed end edge (52a). This end edge (52a), which is intended to come into contact with the hermetic barrier (23), is shaped so as to promote the breaking of the hermetic barrier (23) itself. Preferably the breaking portion (52) has an overall cylindrical conformation. On the opposite side of the connector (51) with respect to the breaking portion (52) a first attachment (56) is positioned for connection to the connection conduit (4). On the same side on which the attachment is arranged for the connection conduit (4) a second attachment (57) is also provided for introducing at least one reactant into the container (21). In the preferred use of the generator, the second attachment (57) enables the introduction of water into the container (21).

Coupling means are provided between the connector (51) and the container (21). Such coupling means are structured in such a way as to produce the insertion of the breaking portion (52) through the opening (22), in order to cause the hermetic barrier (23) to break. The structure of the coupling means therefore allows the container (21) to be opened only when the container (21) is connected to the connector (51). In this way, the reactants contained within the container (21) are not exposed to the atmosphere, and neither are they exposed to any contact with the user.

In a first embodiment the coupling means comprise a threaded coupling (53, 54) interposed between a neck (231) of the container (21) and the connector (51). As shown in FIG. 2, a first thread (53) is arranged inside the neck (231) of the container (21), above the opening (22). A second thread (54) is arranged outside the breaking portion (52), above the end edge (52a). The screwing of the connector (51) to the neck (231) of the container (21) causes pressure of the breaking portion (52) in contact with the hermetic barrier (23) until it causes breaking by the end edge (52a).

In a second embodiment the coupling means may be comprised of a bayonet joint interposed between a neck (231) of the container (21) and the connector (51). As in the case of the threaded coupling, the bayonet joint is structured so as to cause pressure of the breaking portion (52) in contact with the hermetic barrier (23) until it causes breaking by the end edge (52a).

A sealing gasket (55) is arranged concentrically to the breaking portion (52). This gasket (55) is intended to be inserted at least partially within the neck (231) of the container (21). For this purpose the neck (231) has an enlarged upper portion whose function is to facilitate the entrance of the sealing gasket (55) itself.

Preferably the container (21) is provided with a fixing element (24), arranged so as to enable the fixing of the container (21) to a support element. The fixing element (24) is structured so as to enable the angular position of the container (21) to be adjusted with respect to an axis of adjustment (Y).

The fixing element (24) comprises a first body (241), integral with the container (21). A second body (242) is associated with the first body (241) rotatably about the axis of adjustment (Y). Adjustment means are interposed between the first body and the second body so as to enable the locking of the first and the second body in a plurality of relative angular positions. These adjustment means may comprise, for example, a pin integral with the first body (241) and a plurality of housings afforded on the second body (242) and distributed along a circumference arc concentric to the axis of adjustment (Y).

Advantageously the reactor (2) may be provided with a plug, not illustrated, arranged to be applied hermetically to the opening (22) of the container (21). The plug is equipped with a tank provided with a breakable hermetic barrier. This hermetic barrier is arranged to be able to break and put the plug tank in communication with the inside of the container (21) following the application of the plug itself to the opening (22) of the container (21). The tank preferably contains a substance capable of making the products from the gas production reaction inert and/or thicken or solidify them. This further simplifies the overall management of the generator, since the depleted reactants can be closed by means of the plug, making the handling and transport very easy, and the depleted products contained within the reactor can be put into the best conditions for subsequent disposal.

1. A gas generator, comprising: a reactor (2), arranged to contain a preset quantity of reactants; a connection conduit (4), arranged to hermetically connect the reactor (2) to a user (U) of the gas produced; characterised in that: the reactor (2) comprises a container (21) equipped with an opening (22) provided with a breakable hermetic barrier (23); connection means (5) are provided to enable the hermetic and removable connection of the container (21) to the connection conduit (4) and to cause the hermetic barrier (23) to break following the connection between the container (21) and the connection conduit (4).

2. The gas generator according to claim 1, wherein the connection means (5) are structured so to enable the introduction of at least one reactant into the container (21).

3. The gas generator according to claim 1, wherein said connection means (5) comprise a connector (51), associated with the connection conduit (4), which is provided with a breaking portion (52) arranged to break the hermetic barrier (23) following the connection between the container (21) and the connection conduit (4).

4. The gas generator according to claim 3, wherein the breaking portion (52) projects from one side of the container (51) intended to face towards the opening (22) of the container (21) and has a pointed end edge (52a) which is intended to come into contact with the hermetic barrier (23) and is shaped so as to facilitate the breaking of the hermetic barrier (23) itself.

5. The gas generator according to claim 3, comprising coupling means between the connector (51) and the container (21) structured in such a way as to produce an insertion of the breaking portion (52) through the opening (22), in order to cause the hermetic barrier (23) to break.

6. The gas generator according to claim 5, wherein said coupling means comprise a threaded coupling (53, 54) interposed between a neck (231) of the container (21) and the connector (51).

7. The gas generator according to claim 5, wherein said coupling means comprise a bayonet joint interposed between a neck (231) of the container (21) and the connector (51).

8. The gas generator according to claim 3, wherein the connector (51) comprises a first attachment (56) for connection to the connection conduit (4) and a second attachment (57) to enable the introduction of at least one reactant into the container (21).

9. The gas generator according to claim 1, wherein the container (21) is provided with a fixing element (24), arranged to allow the fixing of the container (21) to a support element, which allows the angular position of the container (21) to be adjusted with respect to an axis of adjustment (Y).

10. The gas generator according to claim 9, wherein said fixing element (24) comprises: a first body (241), integral with the container (21); a second body (242), associated with the first body (241) rotatably about the axis of adjustment (Y); adjustment means, interposed between the first body and the second body to enable the locking of the first and the second body in a plurality of relative angular positions.

11. The gas generator according to claim 1, wherein the reactor (2) comprises a plug, arranged to be hermetically applied to the opening (22) of the container (21), which is equipped with a tank provided with a breakable hermetic barrier, said hermetic barrier being arranged to break and put the tank in communication with the inside of the container (21) following the application of the plug to the opening (22) of the container (21).
